(19) United States
(12) Patent Application Publication
(10) Pub. No.: US 2026/0204509 A1
(43) Pub. Date: Jul. 16, 2026

(54) X-RAY SOURCE FOR AN X-RAY IMAGING SYSTEM AND X-RAY IMAGING SYSTEM

(71) Applicant: Carl Zeiss SMT GmbH, Oberkochen (DE)

(72) Inventor: Thomas Anthony CASE, Walnut Creek, CA (US)

(21) Appl. No.: 19/015,774

(22) Filed: Jan. 10, 2025

(51) Int. Cl. H01J 35/18; G01N 23/044; G01N 23/046

(52) U.S. Cl. CPC H01J 35/186; G01N 23/044; G01N 23/046; G01N 2223/1016; G01N 2223/419; H01J 2235/1006; H01J 2235/122

(57) ABSTRACT

An x-ray source for an x-ray imaging system comprises: a vacuum chamber with a vacuum window including a flat outer surface; at least one elongated x-ray target arranged inside the chamber such that its longitudinal axis is inclined relative to the outer surface; and an electron source for emitting a focused electron beam towards the x-ray target causing the x-ray target to emit x-rays through the vacuum window.

### INCORPORATION BY REFERENCE

This application incorporates by reference the following commonly owned applications filed on even date herewith:

USSN ______ (Attorney Docket: 36066-0081001), entitled “X-Ray Imaging System and Method for Operating an X-Ray Imaging System”;

USSN ______ (Attorney Docket: 36066-0082001), entitled “Sample Mount Assembly for An X-Ray Imaging System and X-Ray Imaging System”;

USSN ______ (Attorney Docket: 36066-0083001), entitled “X-Ray Source for an X-Ray Imaging System, X-Ray Imaging System and Method for Operating an X-Ray Imaging System”;

USSN ______ (Attorney Docket: 36066-0084001), entitled “X-Ray Detector Assembly, X-Ray Imaging System and Method for Manufacturing an X-Ray Detector Assembly”; and

USSN ______ (Attorney Docket: 36066-0085001), entitled “X-Ray Imaging System”.

### FIELD

The present disclosure relates to an x-ray source for an x-ray imaging system and an x-ray imaging system with such an x-ray source.

### BACKGROUND

X-rays are widely used in microscopy at least in part because of their short wavelengths and ability to penetrate objects. In x-ray imaging systems, usually so-called tube or laboratory x-ray sources are used in which an electron beam bombards a target such that the target emits x-rays. The resulting x-rays include characteristic lines determined by the target's composition and broad bremsstrahlung radiation.

Some x-ray imaging systems employ a projection configuration in which a small x-ray source spot is used in conjunction with geometric magnification to image the object. A spatial resolution of such an x-ray imaging system at least partially depends on the size of the x-ray source spot. It is often desirable for the x-ray source spot would to be a point spot. In practice, the x-ray source spot is usually considerably larger. Generally, the source spot size is determined at least in part by the electron optics and the ability of those optics to focus the electron beam down to a point. Source spot sizes are generally around 50 to 200 micrometers (μm) with good electron optics, although in other examples x-ray-source spot size may be 1 to 5 millimeters (mm) when power is a more important figure of merit. In general, the larger the volume of the x-ray target generating the x-rays, the larger is the power of the generated x-ray flux. Hence, there often is a trade-off between a small source spot size (i.e. high spatial resolution) and large x-ray power (i.e. high throughput) of an x-ray imaging system.

### SUMMARY

The present disclosure seeks to provide an improved x-ray source for an x-ray imaging system.

According to an aspect, the disclosure provides an x-ray source for an x-ray imaging system which comprises: a vacuum chamber with a vacuum window including a flat outer surface; at least one elongated x-ray target arranged inside the chamber such that its longitudinal axis is inclined relative to the outer surface; and an electron source, optionally accommodated in the chamber, for emitting a focused electron beam towards the x-ray target causing the x-ray target to emit x-rays through the vacuum window.

Thus, the x-ray target is inclined with respect to the outer surface of the vacuum window. This can help allow a desirable orientation of the elongated x-ray target with respect to an x-ray propagation axis of the x-ray imaging system. For example, the elongated x-ray target can be orientated with respect to an x-ray detector of the x-ray imaging system such that a source spot of the x-ray source is relatively small. For example, the elongated x-ray target can be orientated with respect to the x-ray detector such that an x-ray propagation axis from the x-ray target to the detector is coinciding with the longitudinal axis of the x-ray target. In this case, the source spot size of the x-ray source is given by a cross-section area of a cross section of the x-ray target, the cross section being arranged perpendicular to the longitudinal axis of the x-ray target.

By achieving a small source spot size of the x-ray source, a high spatial resolution of the x-ray imaging system can be provided. Thus, small internal structures of the sample can be resolved.

Furthermore, since the x-ray target is an elongated target with the described orientation, the x-ray target can provide a small source spot and can at the same time emit x-rays from its entire volume. Therefore, the proposed x-ray source can have a high power output of x-rays. Due to the high power of the x-rays radiated onto the region of interest of the sample, x-ray exposure times of the sample (e.g., x-ray image acquisition times) can be short. Therefore, a series of samples can be analyzed relatively quickly with the x-ray imaging system resulting in a high throughput rate.

Thus, with the proposed x-ray source, a relatively high spatial resolution x-ray imaging with a high throughput rate of samples can be possible.

The x-ray imaging system is configured for imaging a region of interest of a sample. The sample is, for example, a flat extended object. The sample is, for example, a wafer. The wafer includes, for example, electronic and/or semiconductor components. Just as an example, the x-ray imaging system may be used to inspect the wafer to investigate the quality of packaging of electronic components of the wafer. For example, the quality of mechanical and electrical bonding (e.g., buried interconnections) of the electronic components may be controlled. However, the sample may also be another object than a wafer, such as, for example, a circuit board or a battery.

The x-ray imaging system is, for example, a transmission x-ray imaging system, wherein the x-rays impacting on the region of interest of the sample are partly transmitting the region of interest and are partly absorbed by the region of interest. The position-dependent transmitted portion of the x-rays can be detected by the position-sensitive x-ray detector as a two-dimensional x-ray image.

The x-ray imaging system is, for example, a three-dimensional imaging system. The x-ray imaging system is, for example, configured to obtain two-dimensional transmission images of the region of interest for different rotation angles of the sample. Based on the two-dimensional transmission images, a three-dimensional image of the region of interest can be reconstructed to reveal interior structures of the region of interest. The x-ray imaging system is, for example, an x-ray three-dimensional imaging system obtaining three-dimensional images by x-ray laminography and/or x-ray tomography.

The x-ray source is, for example, a transmission target type x-ray source. The electron beam can strike the at least one x-ray target of the x-ray source at its backside and the at least one x-ray target can be emitted x-rays from its front side, the emitted x-rays are used to irradiate the sample.

The x-ray source can generate diverging x-rays, i.e., a cone (conus) of x-rays. A portion (i.e. a sub cone) of the generated diverging x-rays can irradiate the region of interest of the sample. A center line of this sub cone of x-rays is referred herein as x-ray propagation axis.

The x-ray source typically comprises the vacuum chamber. The electron source and the at least one x-ray target are usually accommodated inside the vacuum chamber in a vacuum atmosphere.

The vacuum window of the vacuum chamber is, for example x-ray transmissive. The flat outer surface of the vacuum window is usually an outer surface with respect to the vacuum chamber, i.e. the outer surface faces an exterior space of the vacuum chamber.

A material of the vacuum window (and/or of a carrier element described below) includes, for example, atomic elements having atomic numbers less than 14. The material of the carrier element includes, for example, one or more of a group including beryllium, diamond, boron carbide, silicon carbide, aluminum, and beryllium oxide. The material of the carrier element can be, for example, diamond.

The vacuum window (and/or the carrier element described below) being x-ray transmissive means, for example, that it has an x-ray transmission such that more than 50% of the x-rays generated by the at least one x-ray target having energies greater than one-half of the selected maximum focused electron energy are transmitted through the carrier element.

The vacuum window (and/or the carrier element described below) has, for example, a sufficiently high thermal conductivity to provide a thermal conduit to prevent thermal damage (e.g., melting) of the at least one x-ray target.

The vacuum window (and/or the carrier element described below) can, for example, also provide an electrically conductive path to dissipate electric charge from the at least one x-ray target, the carrier element itself and/or the vacuum window itself.

The at least one x-ray target is typically configured for emitting x-rays when bombard with the focused electron beam. A material of the at least one x-ray target comprises, for example, one or more of a group including tungsten (W), copper (Cu), chromium (Cr), molybdenum (Mo), rhodium (Rh) and platinum (Pt). The x-rays generated by the at least one x-ray target can include characteristic lines determined by the target's composition and broad bremsstrahlung radiation.

The at least one x-ray target is an elongated x-ray target which is elongated along its longitudinal axis. This means that the at least one x-ray target has a length with respect to its longitudinal axis that is larger than any of its one-dimensional cross-section sizes of its cross section perpendicular to the longitudinal axis. The one-dimensional cross-section sizes include a side length of a square (in case of a squared cross section), a diameter (in case of a circular cross section), side lengths of a rectangular (in case of a rectangular cross section) and a semiaxis, e.g., semimajor axis, of an ellipse (in case of an elliptic cross-section).

A spot size of a source spot of the x-ray source corresponds to (i.e. is equal to) a cross-section size (area) of the at least one x-ray target.

The at least one x-ray target has, for example, a cylindrical geometric shape with a square, circular, rectangular, polygonal and/or elliptic footprint.

The electron source includes, for example, electron optics, to focus and/or direct the electron beam. The electron optics include, for example, one or more magnetic lenses for focusing the electron beam and/or one or more deflection units for deflecting the electron beam.

The electron beam may include a line profile which can, for example, hit the x-ray target at least partly.

A cross section of the focused electron beam at the location of the x-ray target is, for example, as large as or larger than a length of the x-ray target. Hence, the entire x-ray target is usually bombarded by electrons and exited to generate x-rays. Just as an example, the cross section of the focused electron beam has a size (e.g., full width at half maximum, FWHM) at the location of the x-ray target of, for example, a few micrometer, such as 2 μm or larger (e.g., 3 μm or larger, 5 μm or larger).

A power of the focused electron beam has, for example, a value of 5 W or larger, 10 W or larger, 20 W or larger, 30 W or larger, 50 W or larger and/or 70 W or larger.

Because of the inclined x-ray target, the electron beam can hit the x-ray target at an angle which is different from 90° (e.g., an angle of 90° minus the inclination angle of the longitudinal axis of the x-ray target). For example, the electron beam can hit the x-ray target at an angle of 85° or less (e.g., 70° or less, 60° or less, 45° or less, 20° or less).

For example, the longitudinal axis being inclined relative to the outer surface excludes an angle of 90° between the longitudinal axis and the outer surface.

The energy of the electron beam hitting the x-ray target and the generated x-ray flux of the x-ray source are as usual for x-ray sources. Just as an example, the generated x-ray flux of the x-ray source has a value of 8×10¹³ photons/second per Watt for an electron beam with an energy of 75 kV. However, also other numbers can be applied.

According to an embodiment, the x-ray source comprises an x-ray transmissive carrier element, wherein the carrier element includes at least one carrying surface carrying the at least one x-ray target, and the longitudinal axis of the at least one x-ray target is arranged parallel to the at least one carrying surface.

The at least one carrying surface of the carrier element typically carries the at least one x-ray target. The at least one x-ray target is, for example, at least one thin coating of a target material on the at least one carrying surface of the carrier element. The target material is, for example, grown on the at least one carrying surface of the carrier element.

The at least one carrying surface of the carrier element is, for example, a flat surface inclined relative to the outer surface of the carrier element by the inclination angle.

According to some embodiments: the carrier element forms the vacuum window, with the carrier element including the flat outer surface and an inner surface comprising the at least one carrying surface; or the carrier element is a separate component from the vacuum window.

By the carrier element forming the vacuum window, the at least one target carried by the carrier element can be arranged as close as possible to the flat outer surface, i.e., to the exit surface, of the vacuum window.

The inner surface of the carrier element is an inner surface with respect to the vacuum chamber, i.e. the inner surface faces an interior space of the vacuum chamber.

In case that the carrier element is a separate component from the vacuum window, the carrier element can be arranged inside the vacuum chamber and may be arranged at and/or attached to the vacuum window.

According to some embodiments, the x-ray source is configured to be arranged in the x-ray imaging system such that: the at least one carrying surface of the carrier element is arranged parallel to an x-ray propagation axis of the x-ray imaging system; and/or the longitudinal axis of the at least one x-ray target coincides with the x-ray propagation axis of the x-ray imaging system.

The x-ray propagation axis extends, for example, from the x-ray source through a region of interest of the sample to an x-ray detector of the x-ray imaging system.

For example, the x-ray source generates diverging x-rays, i.e., a cone of x-rays. A portion (i.e. a sub cone) of the generated diverging x-rays can irradiate the region of interest of the sample. The x-ray propagation axis is a center beam of the sub cone of x-rays emitted from the x-ray source to the region of interest of the sample. That means the x-ray propagation axis indicates the direction of an x-ray beam which is a portion of the total generated diverging x-rays of the x-ray source.

Furthermore, the x-ray transmissive vacuum window (e. g., the carrier element forming the vacuum window) of the x-ray source can be arranged such that the x-ray propagation axis of the x-ray imaging system intersects the vacuum window.

According to some embodiments, the at least one carrying surface of the carrier element and/or the longitudinal axis of the at least one x-ray target is/are inclined by an inclination angle of 5° or more (e.g., 10° or more, 20° or more, 30° or more, 45° or more) relative to the outer surface of the vacuum window.

For example, the longitudinal axis of the at least one x-ray target may, for example, be arranged at the inclination angle relative to an object plane of the x-ray imaging system.

In some embodiments, the inclination angle can be even smaller than 5° or can be even larger than 45° (e.g., up to 80° or 89°).

According to a further embodiment, the at least one x-ray target has a length with respect to its longitudinal axis that is larger by a factor of 2 or more (e.g., 5 or more, 10 or more, 20 or more, 50 or more, 100 or more) than any of its one-dimensional cross-section sizes of its cross-section perpendicular to the longitudinal axis.

In general, the smaller the one-dimensional cross-section sizes of the at least one x-ray target, the smaller the spot size of the x-ray source is and, hence, the higher the spatial resolution of the x-ray imaging system is.

Furthermore, a larger length of the at least one x-ray target can help provide a larger volume for generating x-rays and, thus, a higher power output of the x-ray source.

By choosing the dimensions of the at least one x-ray target a trade-off between source spot size (and, hence, spatial resolution) and target volume (and, hence, x-ray power and throughput) can be made.

The one-dimensional cross-section sizes include a side length of a square (in case of a squared cross section), a diameter (in case of a circular cross section), side lengths of a rectangular (in case of a rectangular cross section) and a semiaxis, e.g., semimajor axis, of an ellipse (in case of an elliptic cross-section).

According to some embodiments: a length of the at least one x-ray target is between 2 μm and 10 μm, between 3 μm and 8 μm and/or between 4 μm and 5 μm; and/or one-dimensional cross-section sizes of the at least one x-ray target are 2 μm or less (e.g., 1 μm or less, 500 nm or less, 300 nm or less, 100 nm or less, 50 nm or less).

The length of the at least one target is its length with respect to its longitudinal axis. Further, the one-dimensional cross-section sizes are one-dimensional sizes of a cross-section of the at least one x-ray target, wherein the cross-section is perpendicular to the longitudinal axis.

By having a larger length of the at least one x-ray target, x-rays can be generated in a larger volume (higher power output of the x-ray source). However, there is a limit with respect to a maximum distance that the x-rays can travel through the at least one x-ray source. Hence, an upper limit for the length of 10 μm (e.g., 8 μm, 5 μm) may be suitable with respect to this maximum travel distance.

According to some embodiments, the vacuum window and/or a carrier element carrying the at least one x-ray target comprises lateral surfaces, the x-ray source comprises heat dissipation elements in contact with the lateral surfaces, and the vacuum window and/or the carrier element can be configured for dissipating heat transmitted from the at least one x-ray target and for transmitting the heat to the lateral surfaces.

Thus, heat generated in the at least one x-ray target by the impacting electron beam can be transmitted to the vacuum window and/or the carrier element and dissipated to the dissipation elements. The dissipation elements (e.g., copper elements) are, for example, in contact with a water bath for cooling.

For example, in case that the carrier element forms the vacuum window, the carrier element can comprise the lateral surfaces connecting its outer surface with its inner surface, the x-ray source can comprise the heat dissipation elements in contact with portions of the lateral surfaces that are arranged outside of the vacuum chamber, and the at least one carrying surface of the inner surface of the carrier element can be configured for absorbing heat transmitted from the at least one x-ray target and for transmitting the heat to the lateral surfaces.

A thickness of the vacuum window and/or of the carrier element in a direction perpendicular to the outer surface is, for example, sufficiently large (e.g., 100 μm or more, 200 μm or more, 250 μm or more, 300 μm or more) to provide a good heat dissipation.

The lateral surfaces of the vacuum window and/or the carrier element are arranged, for example, perpendicular to the outer surface of the vacuum window.

According to some embodiments, the carrier element comprises at least one notch, and the at least one notch comprises the at least one carrying surface for carrying the at least one x-ray target such that the at least one x-ray target is arranged in the at least one notch.

Thus, the at least one target can be partly embedded in the carrier element. Therefore, a larger surface of the at least one target can be in contact with the carrier element which improves heat dissipation from the at least one target to the carrier element.

According to some embodiments, the x-ray source comprises a plurality of the x-ray targets, wherein the inner surface of the carrier element comprises a plurality of the carrying surfaces carrying the plurality of x-ray targets, respectively, and the plurality of x-ray targets and its corresponding carrying surfaces are arranged in a one-dimensional or a two-dimensional array as viewed in a direction perpendicular to the outer surface of the vacuum window.

By having a plurality of x-ray targets on the carrier element, another x-ray target can be easily selected and used in case that an already used x-ray target became unusable.

The plurality of x-ray targets arranged in the array are, for example, separate x-ray targets which are spaced apart from each other on the carrier element.

The x-ray source comprises, for example, 50 or more x-ray targets (e.g., 100 or more x-ray targets, 1000 or more x-ray targets).

The plurality of x-ray targets are, for example, arranged in a one-dimensional or a two-dimensional array as viewed from a sample mount of the x-ray imaging system.

The plurality of x-ray targets may have all the same properties with respect to their geometric shape, length, one-dimensional cross-section sizes, inclination angles or may differ from each other.

According to some embodiments, the inner surface of the carrier element has a sawtooth shape. Each sawtooth of the sawtooth shape can comprise a first surface region inclining with a first inclination towards the outer surface and a second surface region declining from the first surface region with a second inclination away from the outer surface. An absolute value of the second inclination can be larger than an absolute value of the first inclination. Each first surface region of the sawtooth shape can comprise a respective one of the carrying regions for carrying a respective one of the x-ray targets.

According to a further embodiment, the electron source is configured to direct the electron beam to a respective one of the plurality of x-ray targets to select it as current x-ray target.

Thus, a specific one of the plurality of x-ray targets can be relatively easily selected solely by electronic control of the electron source.

The electron source has, for example, electron optics to direct the electron beam to a specific one of the plurality of x-ray targets.

According to some embodiments, two or more (e.g., all) of the plurality of x-ray targets differ from each other with respect to their length, their one-dimensional cross-section sizes and/or the inclination angle of their longitudinal axes relative to the outer surface of the carrier element.

Hence, by selecting an x-ray target with a specific length and one-dimensional cross-section sizes, a trade-off can be selected between spatial resolution and throughput. By selecting an x-ray target with a specific inclination angle, a suitable inclination angle, e.g., with respect to a region of interest of the sample, can be selected.

That two, more or all of the plurality of x-ray targets differ from each other with respect to the inclination angle of their longitudinal axes relative to the outer surface of the carrier element means also that two, more or all of the plurality of carrying surfaces differ from each other with respect to their inclination angles relative to the outer surface.

According to an aspect, the disclosure provides an x-ray imaging system for imaging a sample. The x-ray imaging system comprises the above-described x-ray source.

According to some embodiments, the x-ray imaging system comprises a position-sensitive x-ray detector for detecting x-rays propagated along an x-ray propagation axis from the x-ray source through a region of interest of the sample to the x-ray detector. The x-ray imaging system can be configured for arranging the x-ray propagation axis: parallel to the at least one carrying surface of the x-ray source; and/or coinciding with the longitudinal axis of the at least one x-ray target of the x-ray source.

The x-ray detector can be configured for detecting x-rays transmitted through the region of interest of the sample. The position-sensitive x-ray detector is, for example, configured to convert the incoming x-rays into light of longer wavelength, e.g., UV-light, visible light or infrared light. The x-ray detector includes, for example, a scintillator material at a transfer field of the detector for converting the x-rays into detectable light and a two-dimensional detector array (e.g., a CCD or CMOS array) for detecting the detectable light. The two-dimensional detector array is, for example, arranged perpendicular to the x-ray propagation axis. A pixel size of the x-ray detector is, for example, 0.5 μm or less (e.g., 0.3 μm or less, 0.1 μm or less).

According to some embodiments, the x-ray imaging system comprises a sample mount with a support surface for supporting the sample, the support surface defining an object plane of the x-ray imaging system. The at least one carrying surface of the carrier element of the x-ray source and/or the longitudinal axis of the at least one x-ray target of the x-ray source can be inclined by an inclination angle of 5° or more (e.g., 10° or more, 20° or more, 30° or more, 45° or more) relative to the object plane, and/or the outer surface of the vacuum window is arranged parallel to the object plane.

According to some embodiments, the x-ray imaging system comprises a sample mount for supporting the sample rotatably around a rotation axis, wherein the x-ray imaging system is configured for obtaining two-dimensional transmission images of the region of interest of the sample for different rotation angles of the sample with respect to the rotation axis, and for reconstructing a three-dimensional image of the region of interest based on the two-dimensional transmission images.

The x-ray imaging system comprises, for example, a control device for reconstructing the three-dimensional images.

The x-ray imaging system can be configured for obtaining two-dimensional transmission images of the region of interest of the sample for different rotation angles of the sample with respect to the rotation axis, wherein the rotation angles span a large angular range of, for example, 180° or more (e.g., 270° or more, 360°).

The embodiments and features described with reference to the x-ray source of the present disclosure apply mutatis mutandis to the x-ray imaging system of the present disclosure.

Further possible implementations or alternative solutions of the disclosure also encompass combinations—that are not explicitly mentioned herein—of features described above or below with regard to the embodiments. The person skilled in the art may also add individual or isolated aspects and features to the most basic form of the disclosure.

### BRIEF DESCRIPTION OF THE DRAWINGS

Further embodiments, features and aspects of the present disclosure will become apparent from the subsequent description and dependent claims, taken in conjunction with the accompanying drawings, in which:

FIG. 1 shows a schematic view of an x-ray imaging system for imaging a sample;

FIG. 2 shows an x-ray source of the x-ray imaging system of FIG. 1;

FIG. 3 shows a carrier element with x-ray targets of the x-ray source of FIG. 2;

FIG. 4 shows an x-ray target of the x-ray source of FIG. 3 in a perspective view;

FIG. 5 shows an enlarged cut-out V of the FIG. 3 displaying a carrying surface of the carrier element with an x-ray target;

FIG. 6 shows a view similar as FIG. 5, wherein the carrier element comprises a notch in which the x-ray target is embedded; and

FIG. 7 shows a carrier element with a plurality x-ray targets of the x-ray source of FIG. 2.

### DETAILED DESCRIPTION

In the Figures, like reference numerals designate like or functionally equivalent elements, unless otherwise indicated.

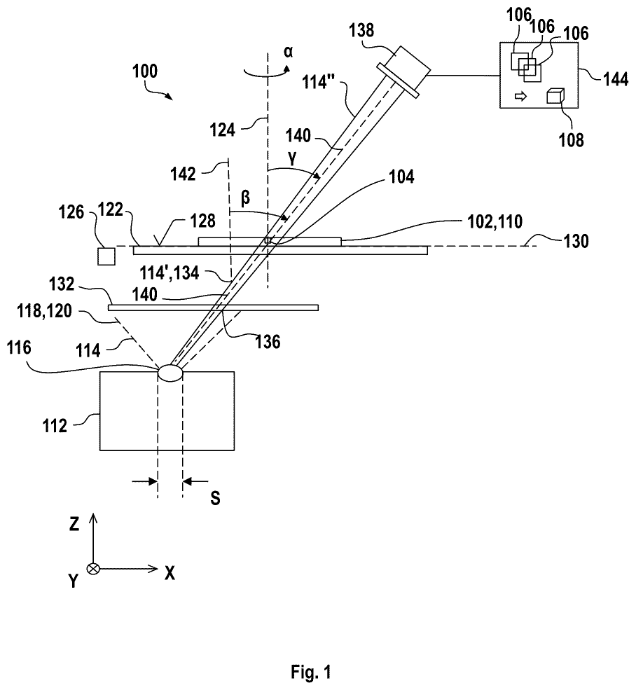

FIG. 1 shows a schematic view of an x-ray imaging system 100 according to an embodiment. The x-ray imaging system 100 is used for imaging a sample 102, for example a region of interest 104 of the sample 102. The x-ray imaging system 100 is configured to obtain two-dimensional transmission images 106 of the region of interest 104 for different rotation angles α of the sample 102. Based on the two-dimensional transmission images 106, a three-dimensional (3D) image 108 of the region of interest 104 is reconstructed to reveal interior structures of the region of interest 104. The x-ray imaging system 100 is, hence, an x-ray 3D imaging system obtaining 3D images 108 by x-ray laminography and/or x-ray tomography.

The sample 102 is, for example, a flat object extended in a main plane (e.g., the xy-plane in FIG. 1). The sample 102 is, for example, a wafer 110 comprising electronic and/or semiconductor components. Just as an example, the x-ray imaging system 100 may be used to inspect the wafer 110 to investigate the quality of packaging of electronic components of the wafer 110. For example, the quality of mechanical and electrical bonding (e.g., buried interconnections) of the electronic components may be controlled.

The x-ray imaging system 100 comprises an x-ray source 112 for emitting x-rays 114. The x-rays 114 are emitted from a source region 116 of the x-ray source 112. The reference sign S denotes a spot size of the source region 116. The x-ray source 112 emits a diverging beam 118 of x-rays 114. In other words, the x-ray source 112 emits a cone 120 of x-rays 114. The sample 102 is arranged within the x-ray emission cone 120.

The x-ray imaging system 100 further comprises a sample mount 122 for supporting the sample 102 rotatably around a rotation axis 124. The rotation axis 124 passes, for example, through the region of interest 104 of the sample 102. For example, the rotation axis 124 can be arranged off-center with respect to a center of the sample 102. A rotation drive 126 for rotating the sample mount 122 and, hence, the sample 102, is shown schematically in FIG. 1. Furthermore, the sample mount 122 has a support surface 128 for supporting the sample 102, wherein the support surface 128 defines an object plane 130 of the x-ray imaging system 100.

The x-ray imaging system 100 may further comprise, for example, a shield stop 132 arranged between the x-ray source 112 and the sample mount 122. The shield stop 132 is, for example, arranged in a light path of the x-rays 114 emitted from the x-ray source 112. The shield stop 132 serves to select a usable portion 134 of the x-ray cone 120. Moreover, the shield stop 132 protects uninspected regions of the sample 102 from x-ray exposure. The shield stop 132 has an aperture 136 through which the usable portion 134 (sub cone 134) of the x-ray light 114 (114′) propagates in the direction of the region of interest 104 of the sample 102 and transmits the region of interest 104 of the sample 102.

The x-ray imaging system 100 further comprises a position-sensitive x-ray detector 138 for detecting x-rays 114″ transmitted through the region of interest 104 of the sample 102. The position-sensitive x-ray detector 138 is, for example, configured to convert the incoming x-rays 114″ into light of longer wavelength, e.g., UV-light, visible light or infrared light. The x-ray detector 138 includes, for example, a scintillator material at a transfer field of the detector 138 for converting the x-rays 114″ into detectable light and a detector array 138 (e.g., a CCD or CMOS array) for detecting the detectable light.

FIG. 1 displays an x-ray propagation axis 140 of the x-ray imaging system 100. For example, a central axis of the portion 134 (sub light cone 134) of the x-ray light 114 passing through the shield stop 132 defines the x-ray propagation axis 140. The x-ray propagation axis 140 extends from the x-ray source 112 (i.e., the source region 116 of the x-ray source 112), through the region of interest 104 of the sample 102, and to the position-sensitive x-ray detector 138.

As can be seen in FIG. 1, the x-ray propagation axis 140 of the x-ray imaging system 100 is, for example, inclined with respect to a surface normal 142 of the sample mount 122 by a first angle β. In addition, the x-ray propagation axis 140 is, for example, inclined with respect to the rotation axis 124 by a second angle γ. In the example of FIG. 1, the surface normal 142 of the sample mount 122 and the rotation axis 124 are arranged parallel to each other and, hence, the first angle β and the second angle γ have the same size.

The x-ray exposures 106 obtained at different rotation angles α of the sample 102 are reconstructed to a 3D image 108 by a control system 144 of the imaging system 100.

The x-ray imaging system 100 provides microscopic imaging. A magnification and, hence, a spatial resolution, of the x-ray imaging system 100 depends on the size of the source region 116 of the x-ray source 112.

Moreover, an imaging time to obtain a 3D image 108 of the region of interest 104 of the sample 102 depends on the x-ray flux density at the region of interest 104. The imaging time limits, for example, a throughput rate when imaging multiple samples 102 with the x-ray imaging system 100.

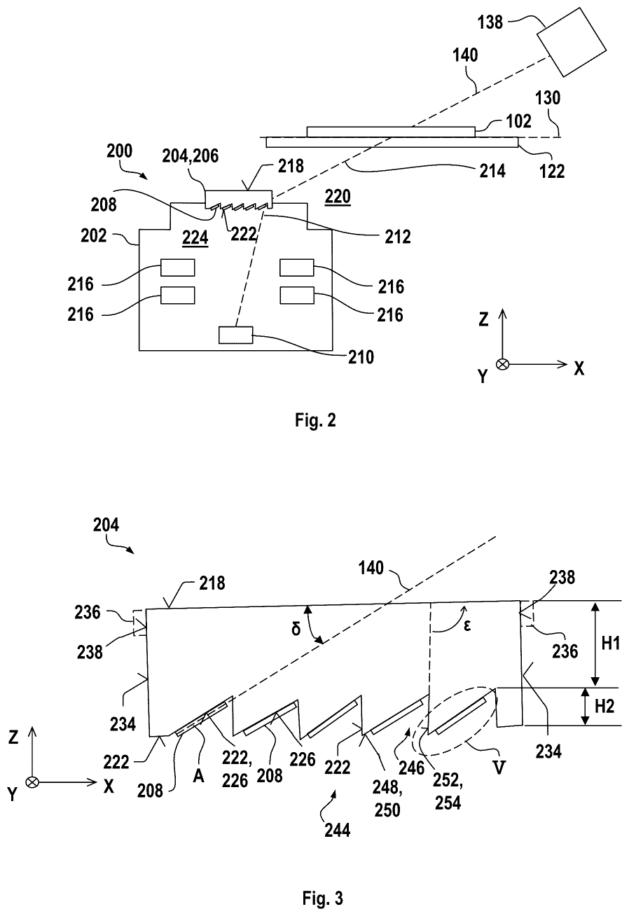

FIG. 2 shows an x-ray source 200 for the x-ray imaging system 100 of FIG. 1. The x-ray source 200 comprises a vacuum chamber 202. The x-ray source 200 further comprises an x-ray transmissive carrier element 204 forming a vacuum window 206 of the vacuum chamber 202. The carrier element 204 is, for example, made from diamond or another suitable material.

In the embodiments shown in the figures and described in the figure description, the x-ray transmissive carrier element 204 forms the vacuum window 206 of the vacuum chamber 202. It is noted that in other embodiments (not shown), the x-ray transmissive carrier element 204 and the vacuum window 206 may be two separate components. In such an embodiment, the x-ray transmissive carrier element 204 may be arranged at and/or attached to the vacuum window 206.

The carrier element 204 carries at least one x-ray target 208. In the example of FIG. 2 four x-ray targets 208 are shown. However, the carrier element 204 may also carry only one x-ray target 208 or may carry more (e.g., many more) than four x-ray targets 208 (e.g., 100 x-ray targets 208 or another number of x-ray targets 208). The at least one x-ray target 208 is, for example, made from tungsten or another suitable material.

It is noted that the carrier element 204 and the x-ray targets 208 are shown at an exaggerated scale in the figures for illustration purposes.

The x-ray source 200 further comprises an electron source 210 accommodated in the vacuum chamber 202. The electron source 210 is configured for emitting a focused electron beam 212 towards the x-ray target 208 (e.g., to a selected one of a plurality of x-ray targets 208). The impacting electron beam 212 causes the (selected) x-ray target 208 to emit x-rays 214 through the vacuum window 206 formed by the carrier element 204. The electron source 210 comprises, for example, electron optics 216 for focusing and directing the electron beam 212 to the (selected) x-ray target 208.

The carrier element 204 has a flat outer surface 218. The outer surface 218 is facing an exterior space 220 of the vacuum chamber 202. The outer surface 218 is, for example, facing the sample mount 122 of the x-ray imaging system 100. Moreover, the outer surface 218 is, for example, arranged parallel to an object plane 130 of the x-ray imaging system 100.

The carrier element 204 has an inner surface 222 arranged opposite its outer surface 218. The inner surface 222 is facing an interior space 224 of the vacuum chamber 202. The at least one x-ray target 208 is carried by the inner surface 222 of the carrier element 204, as can be seen in FIG. 3. For example, the inner surface 222 comprises at least one carrying surface 226 carrying the at least one x-ray target 208. In the example of FIGS. 2, 3, the inner surface 222 comprises five carrying surfaces 226 each carrying one x-ray target 208. However, also more than five carrying surfaces 226 or less than five carrying surfaces 226 can be provided.

The at least one carrying surface 226 of the carrier element 204 is inclined relative to the outer surface 218 of the carrier element 204 by an inclination angle δ. The inclination angle δ has, for example, a value of 20°. However, the inclination angle δ can also have a value different from 20°. Since a longitudinal axis A of the at least one elongated x-ray target 208 is arranged parallel to the at least one carrying surface 226, also the at least one x-ray target 208 is inclined relative to the outer surface 218 of the carrier element 204 by the inclination angle δ.

The outer surface 218 of the carrier element 204 may be arranged parallel to the object plane 130 of the x-ray imaging system 100. In this case, the at least one carrying surface 226 of the carrier element 204 and the longitudinal axis A of the at least one x-ray target 208 are inclined by the inclination angle relative to the object plane 130.

As shown in FIG. 3, the carrier element 204 may have a height H1 in a z-direction (e. g., a direction perpendicular to the outer surface 218) which is, for example, 100 μm or larger, 200 μm or larger, 250 μm or larger, 300 μm or larger and/or 400 μm or larger. Further, the indentations of the carrier element 204 which form the inclined carrying surfaces 226, may have a height H2 in the z-direction of, for example, 5 μm or smaller, 3 μm or smaller, 2 μm or smaller and/or 1 μm or smaller.

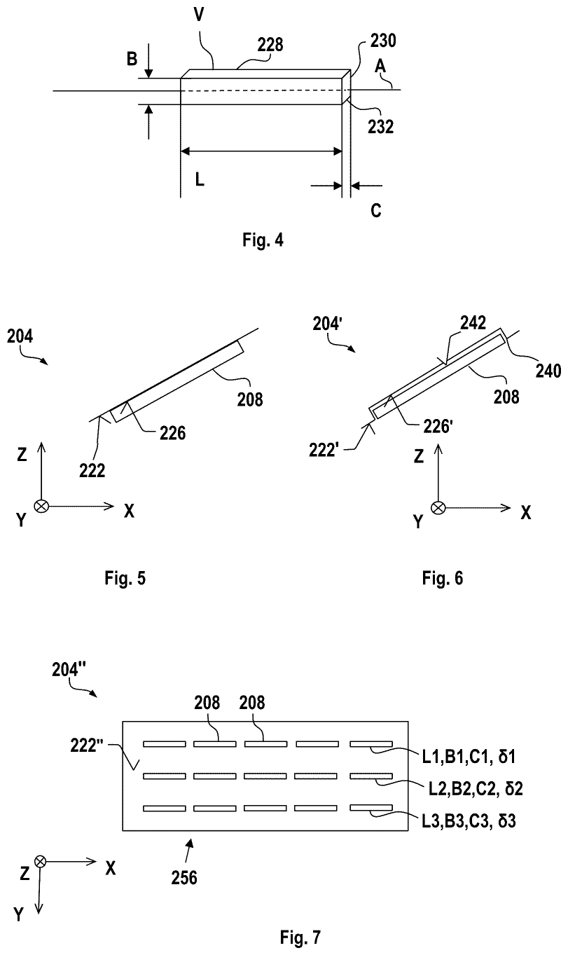

FIG. 4 shows a perspective view of one of the x-ray targets 208 of FIG. 3. The x-ray target 208 has as an example a cylindrical geometric shape 228 with a squared footprint 230. The reference sign L denotes a length of the at least one elongated x-ray source 208 with respect to its longitudinal axis A. Further, the reference signs B, C each denotes a side length of the squared footprint (here B=C, since it is a square) of the at least one elongated x-ray source 208. However, the x-ray targets 208 of the x-ray source 200 can also have a different geometric shape. In any case, a length L of the at least one elongated x-ray source 208 is much larger than any of its one-dimensional cross-section sizes B, C of its cross-section perpendicular to the longitudinal axis A. The length L is, for example, 20 times larger than any of its one-dimensional cross-section sizes B, C. However, the at least one elongated x-ray source 208 may also have another ratio of its length L and one-dimensional cross-section sizes B, C than 20.

Just as an example, is a length of the at least one x-ray target 208 5 μm and is the one-dimensional cross-section size B, C of the at least one x-ray target 208 300 nm. However, also different numbers can be applied for these dimensions L, B, C.

As displayed in FIGS. 2 and 3, having the described configuration of the carrier element 204 with the inclined carrying surfaces 226 and the inclined elongated x-ray targets 208 can help allow use of the x-ray source 200 in the imaging system 100. For example, the at least one carrying surface 226 of the carrier element 204 can be arranged parallel to the x-ray propagation axis 140 of the x-ray imaging system 100. Further, the longitudinal axis A of the at least one x-ray target 208 can be arranged such that it coincides with the x-ray propagation axis 140 of the x-ray imaging system 100. Thus, with such an arrangement the spot size S of the source region 116 (FIG. 1) is defined by the cross-section area 232 (FIG. 4) of the at least one x-ray target 208. Since the cross-section area 232 is small, the spatial resolution of the x-ray imaging system 100 is high (e.g., sufficient to resolve 300 nm large structures of the sample 102). Nevertheless, x-rays 114, 214 can be generated in the whole volume V of the at least one x-ray target 208 and emitted through the cross-section area 232 along the x-ray propagation axis 140. Therefore, the x-ray source 200 can output a large x-ray flux.

As shown in FIG. 3, the carrier element 204 can be used for dissipating heat from the at least one x-ray target 208. For example, the carrier element 204 comprises lateral surfaces 234 connecting the outer surface 218 with the inner surface 222. The x-ray source 200 further comprises heat dissipation elements 236 in contact with portions 238 of the lateral surfaces 234 that are arranged outside of the vacuum chamber 202 (FIG. 2). Furthermore, the at least one carrying surface 226 of the inner surface 222 of the carrier element 204 is configured for absorbing heat transmitted from the at least one x-ray target 208 and for transmitting the heat to the lateral surfaces 234 and to the heat dissipation

elements 236. The heat dissipation elements 236 may be in contact with a water bath (not shown) or the like for cooling.

FIG. 5 shows an enlarged cut-out V from FIG. 3. In FIG. 5, a portion of the inner surface 222 of the carrier element 204 is shown. For example, in FIG. 5 one of the carrying surfaces 226 of the inner surface 222 are visible. Further, one of the x-ray targets 208 arranged on the carrying surfaces 226 is displayed in FIG. 5.

FIG. 6 shows a view similar as FIG. 5, but with an inner surface 222′ of a carrier element 204′ configured according to a further embodiment. For example, the carrier element 204′ comprises at least one notch 240. Further, the at least one notch 240 comprises the at least one carrying surface 226′ for carrying the at least one x-ray target 208 such that the at least one x-ray target 208 is arranged in the at least one notch 240.

By arranging the at least one x-ray target 208 in the at least one notch 240, a cooling of the at least one x-ray target 208 can be improved since a larger surface 242 of the at least one x-ray target 208 is in contact with the carrier element 204′ for heat dissipation.

As shown in FIGS. 2 and 3, the x-ray source 200 can comprise a plurality of x-ray targets 208 carried by a plurality of carrying surfaces 226, each carrying surfaces 226 being inclined with respect to the outer surface 218 and, for example, also inclined with respect to the object plane 130. Hence, in the inner surface 22 of the carrier element 204 can have a sawtooth shape 244, as can be seen in FIG. 3. Each sawtooth 246 (one of them is denoted with a reference sign in FIG. 3) of the sawtooth shape 244 comprises a first surface region 248 inclining with a first inclination 250 (angle δ) towards the outer surface 218. Further, each sawtooth 246 comprises a second surface region 252 declining from the first surface region 248 with a second inclination 254 (angle ε) away from the outer surface 218. An absolute value of the second inclination 254 is larger than an absolute value of the first inclination 250. In addition, each first surface region 248 of the sawtooth shape 244 comprises a respective one of the carrying regions 226 for carrying a respective one of the x-ray targets 208.

FIG. 7 shows a bottom view (view in positive z-direction in FIG. 3) of a carrier element 204″ according to a further embodiment. The inner surface 222″ of the carrier element 204″ comprises a plurality of carrying surfaces carrying a plurality of x-ray targets 208 (two of them are denoted with a reference sign in FIG. 7), respectively. As can be seen in FIG. 7, the plurality of x-ray targets 208 and their corresponding carrying surfaces (not visible in FIG. 7 because they are arranged below the x-ray targets 208) are arranged in a two-dimensional array 256 as viewed in a direction z perpendicular to the outer surface 218 (FIG. 3) of the carrier element 204″.

The x-ray targets 208 of the array 256 can have all the same properties. Alternatively, two, more or all of the plurality of x-ray targets 208 may differ from each other with respect to their length L1, L2, L3, their one-dimensional cross-section sizes B1, B2, B3, C1, C2, C3 and/or the inclination angle δ1, δ2, δ3 of their longitudinal axes A (FIG. 3) relative to the outer surface 218 of the carrier element 204, 204″. Such different properties are indicated for some of the of x-ray targets 208 in FIG. 7 by reference signs. Hence, by selecting a specific x-ray target 208 with a specific length L1 and specific one-dimensional cross-section sizes B1, C1, a trade-off can be selected between the spatial resolution and the throughput of the imaging system 100. In addition, by selecting an x-ray target 208 with a specific inclination angle δ1, a suitable inclination angle, e.g., with respect to a region of interest 104 of the sample 102, can be selected.

Although the present disclosure has been described in accordance with certain embodiments, it is obvious for the person skilled in the art that modifications are possible in all embodiments.

### Reference Numerals

100 System
102 Sample
104 Region of interest
106 2D-Image
108 3D-Image
110 Wafer
112 Source
114 X-ray
114′,114″ X-ray
116 Source region
118 Beam
120 Cone
122 Mount
124 Axis
126 Rotation drive
128 Surface
130 Plane
132 Shield stop
134 Portion
136 Aperture
138 Detector
140 Axis
142 Surface normal
144 Control system
200 Source
202 Vacuum chamber
204 Carrier element
204′, 204″ Carrier element
206 Window
208 Target
210 Source
212 Beam
214 X-ray
216 Optics
218 Outer surface
220 Exterior space
222 Inner surface
222′, 222″ Inner surface
224 Interior space
226, 226′ Carrying surface
228 Shape
230 Footprint
232 Area
234 Lateral surface
236 Element
238 Portion
240 Notch
242 Surface
244 Sawtooth shape
246 Sawtooth
248 Surface region
250 Inclination
252 Surface region
254 Inclination
256 Array
α Angle
β Angle
γ Angle
δ Angle
δ1-δ3 Inclination angle
ε Angle
A Axis
B Size
B1-B3 Size
C Size
C1-C3 Size
H1, H2 Height
L Length
L1-L3 Length
S Size
V Volume
X Direction
Y Direction
Z Direction

What is claimed is:

1. An x-ray source, comprising:
a vacuum chamber comprising a vacuum window which comprises a flat outer surface;
an elongated x-ray target inside the vacuum chamber, the elongated x-ray target having its longitudinal axis inclined relative to the flat outer surface of the vacuum window; and
an electron source configured to emit a focused electron beam toward the elongated x-ray target to cause the elongated x-ray target to emit x-rays through the vacuum window.

2. The x-ray source of claim 1, further comprising an x-ray transmissive carrier element which comprises a carrying surface carrying the elongated x-ray target so that the longitudinal axis of the elongated x-ray target is parallel to the carrying surface.

3. The x-ray source of claim 2, wherein the x-ray transmissive carrier element defines the vacuum window, the x-ray transmissive carrier element comprises the flat outer surface of the vacuum window, and the x-ray transmissive carrier element comprises an inner surface which comprises the carrying surface.

4. The x-ray source of claim 2, wherein the carrier element is a separate component from the vacuum window.

5. The x-ray source of claim 2, wherein the carrier element comprises a notch, and the notch comprises the carrying surface so that the elongated x-ray target is in the notch.

6. The x-ray source of claim 2, comprising a plurality of the elongated x-ray targets, wherein:
the inner surface of the carrier element comprises a plurality of carrying surfaces;
each carrying surface carries a corresponding elongated x-ray target;
each carrying surface and its corresponding elongated x-ray target is in a one-dimensional or a two-dimensional array as viewed in a direction perpendicular to the flat outer surface of the vacuum window.

7. The x-ray source of claim 6, wherein:
the inner surface of the carrier element has a sawtooth shape comprising a plurality of saw teeth;
each sawtooth comprises a first surface region that is inclined towards the outer surface with a first inclination;
each sawtooth has a second surface region that is declined away from the first surface region with a second inclination;
an absolute value of the second inclination is greater than an absolute value of the first inclination; and
each first surface region of the sawtooth shape comprises a corresponding carrying surface.

8. The x-ray source of claim 6, wherein the electron source is configured to selectably direct the electron beam to one of the plurality of elongated x-ray targets to select it as a current elongated x-ray target.

9. The x-ray source of claim 6, wherein at least two of the elongated x-ray targets differ from each other with respect to a length, a one-dimensional cross-section size, and/or an inclination angle of their longitudinal axes relative to the flat outer surface of the carrier element.

10. The x-ray source of claim 1, wherein the x-ray source is arrangeable in an x-ray imaging system so that:
the carrying surface is parallel to an x-ray propagation axis of the x-ray imaging system; and/or
the longitudinal axis of the elongated x-ray target coincides with the x-ray propagation axis of the x-ray imaging system.

11. The x-ray source of claim 1, wherein the carrying surface and/or the longitudinal axis of the elongated x-ray target is/are inclined by an inclination angle of at least 5° relative to the outer surface of the vacuum window.

12. The x-ray source of claim 1, wherein the elongated x-ray target has a length along its longitudinal axis that is at least twice as large as any of its one-dimensional cross-section sizes of its cross-section perpendicular to the longitudinal axis.

13. The x-ray source of claim 1, wherein:
a length of the elongated x-ray target is between 2 μm and 10 μm; and/or
one-dimensional cross-section sizes of the elongated x-ray target are 2 μm or less.

14. The x-ray source of claim 1, wherein:
the vacuum window and/or a carrier element carrying the elongated x-ray target comprises/comprise lateral surfaces;
the x-ray source comprises heat dissipation elements contacting the lateral surfaces; and
the vacuum window and/or the carrier element is/are configured to dissipate heat transmitted from the elongated x-ray target and to transmit the heat to the lateral surfaces.

15. A system, comprising:
an x-ray source according to claim 1 configured to direct x-rays to a sample,
wherein the system is an x-ray imaging system configured to image the sample.

16. The system of claim 15, further comprising:
a position-sensitive x-ray detector configured to detect x-rays propagated along an x-ray propagation axis from the x-ray source, through a region of interest of the sample, and to the x-ray detector,
wherein the x-ray imaging system is configured to arrange the x-ray propagation axis:
parallel to the carrying surface of the x-ray source; and/or
coinciding with the longitudinal axis of the elongated x-ray target of the x-ray source.

17. The system of claim 16, further comprising a sample mount which comprises a support surface to support the sample, wherein the support surface defines an object plane of the system, and wherein:
the carrying surface and/or the longitudinal axis of the x-ray target is/are inclined by an angle of 5° or more relative to the object plane; and/or
the outer surface of the vacuum window is parallel to the object plane.

18. The system of claim 16, further comprising a sample mount configured to support the sample rotatably around a rotation axis, wherein the system is configured to obtain two-dimensional transmission images of the region of interest of the sample for different rotation angles of the sample with respect to the rotation axis, and the system is configured to reconstruct a three-dimensional image of the region of interest based on the two-dimensional transmission images.

19. The system of claim 15, further comprising a sample mount which comprises a support surface to support the sample, wherein the support surface defines an object plane of the system, and wherein:
the carrying surface and/or the longitudinal axis of the x-ray target is/are inclined by an angle of 5° or more relative to the object plane; and/or
the outer surface of the vacuum window is parallel to the object plane.

20. The system of claim 15, further comprising a sample mount configured to support the sample rotatably around a rotation axis, wherein the system is configured to obtain two-dimensional transmission images of the region of interest of the sample for different rotation angles of the sample with respect to the rotation axis, and the system is configured to reconstruct a three-dimensional image of the region of interest based on the two-dimensional transmission images.
